(19) United States
(12) Patent Application Publication
(10) Pub. No.: US 2026/0219117 A1
(43) Pub. Date: Jul. 30, 2026

(54) OPTICAL MEASUREMENT SYSTEM AND OPTICAL MEASUREMENT METHOD

(71) Applicant: NTT. Inc., Tokyo (JP)

(72) Inventors: Takahiro ISHIMARU, Musashino-shi, Tokyo (JP); Yoshifumi WAKISAKA, Musashino-shi, Tokyo (JP); Daisuke IIDA, Musashino-shi, Tokyo (JP); Tatsuya OKAMOTO, Musashino-shi, Tokyo (JP); Tomokazu ODA, Musashino-shi, Tokyo (JP); Yusuke KOSHIKIYA, Musashino-shi, Tokyo (JP)

(73) Assignee: NTT. Inc., Tokyo (JP)

(21) Appl. No.: 18/722,457

(22) PCT Filed: Dec. 24, 2021
(86) PCT No.: PCT/JP2021/048201

§ 371 Date: Jun. 20, 2024

(51) Int. Cl. G01L 1/24; G01K 11/322

(52) U.S. Cl. CPC G01L 1/242; G01K 11/322

(57) ABSTRACT

The present disclosure is an optical measurement system for measuring Rayleigh scattered light and Brillouin scattered light in an optical fiber by injecting light into both ends of the optical fiber, wherein injected light for the Rayleigh scattering includes frequency multiplexing pulses, and one pulse of the frequency multiplexing pulses is used as pump light for the Brillouin scattering.

### TECHNICAL FIELD

The present disclosure relates to an optical measurement system and an optical measurement method for measuring scattered light generated by injecting light into an optical fiber.

### BACKGROUND ART

A system that combines phase optical time domain reflectometry (OTDR) based on Rayleigh scattering and Brillouin optical time domain analysis (BOTDA) based on Brillouin scattering to simultaneously measure a rapid change in strain, and slow changes in strain and temperature has been proposed (refer to Non Patent Literature 1, for example). The phase OTDR of Non Patent Literature 1, in which a rapid changes in strain is detected on the basis of a change in scattered light intensity, is qualitative measurement, and cannot accurately and quantitatively measure the magnitude and waveform of the change in strain. In addition, there are many points where the measurement sensitivity of changes in strain deteriorates due to fading noise.

On the other hand, as a technique for improving the sensitivity of changes in strain in the system of the phase OTDR alone, there is a technique for removing fading noise and performing quantitative measurement of a rapid change in strain by frequency multiplexing pulses (hereinafter, referred to as frequency-division multiplexing (FDM) pulses) and signal processing (refer to Patent Literature 1, for example). In Patent Literature 1, as injected pump light, FDM pulses having a plurality of frequencies are used instead of pulses having a single frequency. Individual components are extracted with a frequency filter from Rayleigh scattering caused by injected light of FDM pulses, and an average of the individual frequency components is obtained to obtain a phase. By observing this change in phase, it is possible to quantitatively measure a rapid change in strain with high sensitivity. Note that, since each frequency component of the FDM pulses is shifted by the time of another pulse width present immediately before, each component is extracted with the frequency filter and, subsequently, time of the pulse width is shifted to align the start points of the individual frequency components.

In the system configuration of Non Patent Literature 1, it is possible to simply combine FDM phase OTDR and BOTDA by changing light pulses used for phase OTDR measurement to FDM light pulses and calculating the phase of Rayleigh scattered light as in Patent Literature 1. However, when they are simply combined, frequency bands of Brillouin gain spectra (BGS), generated in measurement of BOTDA, overlap depending on the interval between the optical frequency components of the injected FDM pulses as the pump light and the magnitude of the pulse width. As a result, it is difficult to measure BOTDA simultaneously with FDM phase OTDR, and it is difficult to simultaneously perform highly sensitive measurement of a rapid change in strain due to Rayleigh scattered light and measurement of slow changes in strain and temperature due to Brillouin scattered light.

### CITATION LIST

### Patent Literature

Patent Literature 1: JP 2020-169904 A

### Non Patent Literature

Non Patent Literature 1: Coscetta, E. Catalano, E. Cerri, N. Cennamo, L. zeni, and A. Minardo, “Hybrid Brillouin/Rayleigh sensor for multiparameter measurements in optical fibers,” Opt. Exp., vol. 29, no. 15, pp. 24025-24031, 2021.
Non Patent Literature 2: J. Smith, A. Brown, M. DeMerchant, X. Bao, “Pulse width dependence of the Brillouin loss spectrum”, Opt. Com., vol. 168, Issues. 5-6, pp. 393-398, 1999.
Non Patent Literature 3: Yonas Muanenda, Claudio J. Oton, Fabrizio Di Pasquale, “Application of Raman and Brillouin scattering phenomena in distributed optical fiber sensing”, frontiers in Physics, vol. 7, Article 155, pp. 1-14, 2019.

### SUMMARY OF INVENTION

### Technical Problem

An object of the present disclosure is to enable simultaneous measurement of Rayleigh scattering and Brillouin scattering.

### Solution to Problem

An optical measurement system and an optical measurement method of the present disclosure are an optical measurement system and an optical measurement method for measuring Rayleigh scattered light and Brillouin scattered light in an optical fiber by injecting light into both ends of the optical fiber,
wherein injected light for the Rayleigh scattering includes frequency multiplexing pulses having a predetermined frequency interval, and
one pulse of the frequency multiplexing pulses is used as pump light for the Brillouin scattering.

### Advantageous Effects of Invention

According to the present disclosure, it is practical to simultaneously measure Rayleigh scattering and Brillouin scattering by using, as injected light, frequency multiplexing pulses having a frequency interval determined in consideration of a spread of a frequency spectrum due to an injected pulse and BGS.

### BRIEF DESCRIPTION OF DRAWINGS

FIG. 1 is a system configuration diagram illustrating an example of an embodiment of the present disclosure.

FIG. 2 is an explanatory diagram of an FDM pulse used as pump light in the present disclosure.

FIG. 3 is an explanatory diagram of frequency bands of injected light and Brillouin scattering.

FIG. 4 is a flowchart illustrating an example of an optical measurement method of the present disclosure.

### DESCRIPTION OF EMBODIMENTS

Hereinafter, embodiments of the present disclosure will be described in detail with reference to the drawings. Note that the present disclosure is not limited to the following embodiments. These examples are merely examples, and the present disclosure can be implemented in a form with various modifications and improvements based on the knowledge of those skilled in the art. Note that components having the same reference numerals in the present specification and the drawings indicate the same components.

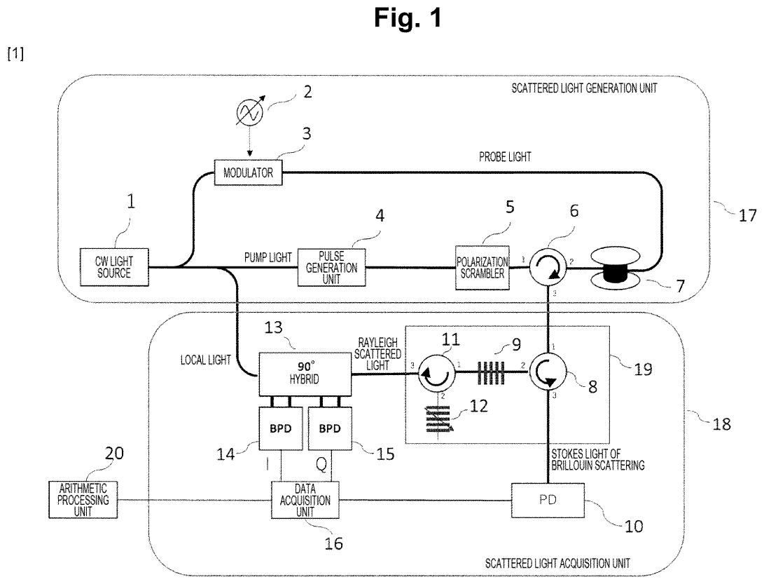

FIG. 1 illustrates a system configuration according to an embodiment of the present disclosure. The optical measurement system according to the present embodiment includes a scattered light generation unit 17 that generates Rayleigh scattering and Brillouin scattering in a fiber under test (FUT) 7, a scattered light acquisition unit 18 that acquires Rayleigh scattered light and Brillouin scattered light generated in the FUT 7, and an arithmetic processing unit 20. The FUT 7 can be any medium capable of generating Rayleigh scattering and Brillouin scattering, and may be, for example, a silica single mode fiber. The optical measurement system according to the present embodiment simultaneously performs both measurement of a rapid change in strain based on FDM phase OTDR and measurement of slow changes in strain and temperature based on BOTDA using these components.

The scattered light generation unit 17 simultaneously generates Rayleigh scattering and Brillouin scattering in the FUT 7 using frequency multiplexing pulses (hereinafter, referred to as FDM pulses) as injected light. Accordingly, the optical measurement system of the present disclosure simultaneously executes the phase OTDR using the Rayleigh scattered light generated, by the FDM pulses, in the FUT 7 and the BOTDA based on Brillouin scattering using the FDM pulses as pump light. Here, since the FDM pulses have a frequency spread, Brillouin scattering is generated using only one pulse of the FDM pulses as the pump light.

Specifically, the scattered light generation unit 17 is a unit that acquires Rayleigh scattering and Brillouin scattering, and includes a CW light source 1 that emits continuous light such as a laser, a modulation signal generator 2, a modulator 3, a pulse generation unit 4, a polarization scrambler 5, a circulator 6 that extracts only light scattered in an injection direction, and the FUT 7.

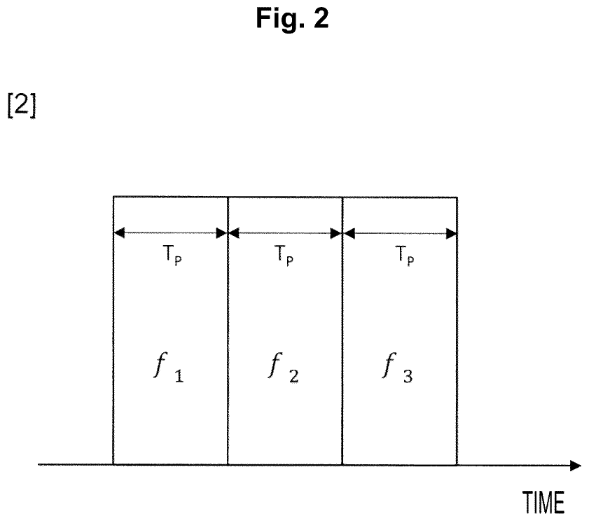

The scattered light generation unit 17 divides the continuous light, from the CW light source 1, into two light beams of pump light and probe light. The modulation signal generator 2 and the modulator 3 sweep the frequency of the probe light in a range of Brillouin frequency shift normally used in BOTDA in an optical fiber. The pulse generation unit 4 converts the pump light into FDM pulses having different frequencies as illustrated in FIG. 2. In the present embodiment, an example in which differences between the optical frequency of the CW light source 1 and the center frequencies of respective frequency components are f₁, f₂, and f₃ will be described as an example of the FDM pulses. The polarization scrambler 5 randomizes polarization of the FDM pulses between pulses at different timings and lets the FDM pulses into the circulator 6. As a result, the polarization dependence of stimulated Brillouin scattered light is averaged. The circulator 6 lets the FDM pulses, from the polarization scrambler 5, into the FUT 7.

In the FUT 7, Rayleigh scattering occurs due to the FDM pulses. Further, in the FUT 7, Brillouin scattering occurs due to the probe light and the FDM pulses. The circulator 6 outputs backscattered light of the FDM pulses to the scattered light acquisition unit 18. As a result, the Rayleigh scattered light generated in the FUT 7 is output to the scattered light acquisition unit 18. Further, the circulator 6 adds the stimulated Brillouin scattered light to the probe light and outputs the light that has passed in the FUT 7 to the scattered light acquisition unit 18. As a result, the Brillouin scattered light generated through the FUT 7 is output to the scattered light acquisition unit 18.

The scattered light acquisition unit 18 includes a separation unit 19 that separates and detects the acquired two types of scattered light, a photodetector (PD) 10, a 90° hybrid 13, balanced photodetectors (BPDs) 14 and 15, and a data acquisition unit 16. The data acquisition unit 16 can also be realized by a computer and a program, and the program can be recorded in a recording medium or provided through a network.

The separation unit 19 includes circulators 8 and 11 and fiber Bragg gratings (FBGs) 9 and 12. The scattered light from the FUT 7 is separated into Brillouin scattered light and Rayleigh scattered light using the FBGs 9 and 12 in the separation unit 19. For example, a wavelength corresponding to Brillouin scattering is reflected by the FBG 9 and detected by the photodetector (PD) 10. In addition, a wavelength, corresponding to Rayleigh scattered light of the FDM pulses, of the transmitted light of the FBG 9 is reflected by the FBG 12 and is injected into the 90° hybrid 13. Here, the reflection wavelength in the FBG 9 may be a wavelength of Stokes light generated by Brillouin scattering.

The 90° hybrid 13 and the BPDs 14 and 15 function as a reception unit of Rayleigh scattered light. In the 90° hybrid 13, phase diversity homodyne detection using local light is performed. In the balanced photodetectors (BPDs) 14 and 15, I component and Q component signals detected by the 90° hybrid 13 are acquired. The PD 10 and the BPDs 14 and 15 are connected to the data acquisition unit 16. The data acquisition unit 16 converts an input signal that is an analog signal to a digital signal and stores the digital signal.

The data acquisition unit 16 stores the signal intensity of a frequency component after Brillouin frequency shift (BFS) from the PD 10. The arithmetic processing unit 20 can obtain a BGS using the signal intensity of the frequency component after the BFS stored in the data acquisition unit 16.

Further, the data acquisition unit 16 also stores the signal intensities of the I component and the Q component of the Rayleigh scattered light. The arithmetic processing unit 20 can obtain the phase in the FUT 7 using the signal intensities of the I component and the Q component of the Rayleigh scattered light stored in the data acquisition unit 16.

Therefore, the present disclosure makes it practical to simultaneously perform highly sensitive measurement of a rapid change in strain due to Rayleigh scattered light and measurement of slow changes in strain and temperature due to Brillouin scattered light.

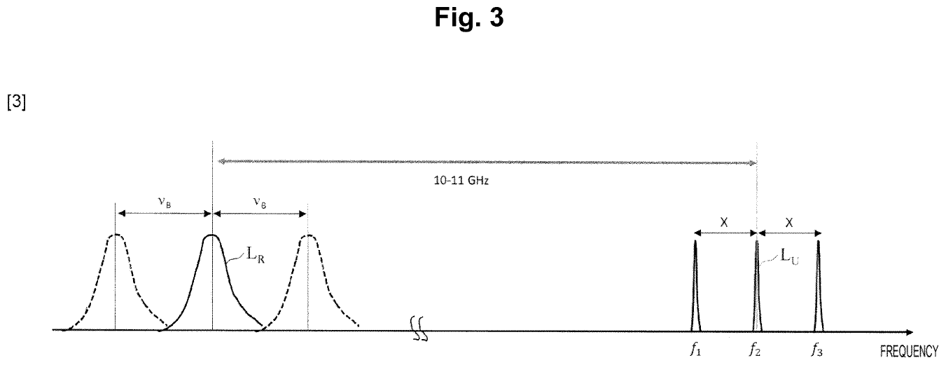

Here, Brillouin scattering in simultaneous measurement will be described with reference to FIG. 3. Brillouin scattering is scattered light having a component in a frequency band 10 to 11 GHz away from injected pump light L_{U}. This frequency 10 to 11 GHZ away from the pump light L_{U} is referred to as a Brillouin Frequency Shift (BFS). BGSLR can be obtained by frequency sweeping the vicinity of the BFS with probe light. By observing a change in position of a peak of the BGS on the frequency axis, it is practical to measure slow changes in strain and temperature.

The shape of the BGS depends on the characteristics of the injected pump light. Since the injected pump light L_{U} in the present disclosure is FDM pulses as illustrated in FIG. 2, the pump light L_{U} itself has a frequency spread. The frequency spread depends on the pulse width T_{P} of the FDM pulses, and increases as the pulse width T_{P} decreases. As the shape of the FDM pulses used in the present disclosure, any shape can be used as long as the intended BOTDA and phase OTDR can be implemented, but a rectangular pulse can be used, as illustrated in FIG. 2, for example.

In this regard, the spread of the frequency of the FDM pulses (hereinafter, also referred to as a pulse spectrum) is expressed by the following formula from the Fourier transform X(ω) of a pulse having a width 2a.

$$\begin{matrix}[ Math . 1 ] & \\ X ( ω ) = 2 a \frac{sin ω a}{ω a} & ( 1 )\end{matrix}$$

Here, ω represents an angular frequency, and the value of X(ω) makes it practical to ascertain how much pulse light includes a component of a certain angular frequency ω. A first point of X(ω)=0 from the peak is ω=−π/a, π/a. From Formula (1), it can be ascertained that the frequency band already has a spread depending on the pulse width at the time of the FDM pulses before injection into the FUT 7.

The FDM pulses are injected into the FUT 7 to acquire Brillouin scattered light. In addition, at the time of acquiring the BGS, the frequency band is wider from the pump light L_{U}. According to Non Patent Literature 2, the BGS in consideration of the pulse width T_{P} of the pump light L_{U} is expressed by the following formula obtained by convoluting the pulse spectrum of the FDM pulses and a gain spectrum with assumption that the pump light is a continuous wave at a single frequency.

$$\begin{matrix}[ Math . 2 ] & \\ P ( v ) = {P}_{cw} {e}^{- α L} [ 1 - exp ( - {g}_{B} {P}_{P} \frac{{L}_{eff}}{{A}_{eff}} \times {\int }_{- ∞}^{∞} \frac{sin [ π ( {v}^{′} - {v}_{0} ) {T}_{P} ]}{π ( {v}^{′} - {v}_{0} ) ( 1 + {( \frac{2 ( v - {v}^{′} )}{Δ {v}_{b}} )}^{2} )} {dv}^{′} ) ] & ( 2 )\end{matrix}$$

$${L}_{eff} = \frac{1}{α} ( 1 - {e}^{- α L} ) \qquad ( 2.1 )$$

$${L}_{eff} = \frac{{cT}_{P}}{2 n} \qquad ( 2.2 )$$

In Formula (2), P_{CW} represents the power of the probe light, Pp represents the power of the pump light L_{U}, L represents the total length of the optical fiber: FUT 7, A_{eff} represents the core area of the optical fiber: FUT 7, T_{P} represents the pulse width of the FDM pulses on the time axis, α represents the attenuation coefficient of the optical fiber: FUT 7, g_{B} represents a Brillouin gain, Δν_{B} represents the full width at half maximum of BGS, ν represents the frequency of a certain point in BGS, and ν₀ represents a frequency at which Brillouin scattering occurs. As α, an attenuation coefficient of a linear optical fiber can be used. L_{eff} is called an interaction length and is expressed by Formulas (2.1) and (2.2). c represents the speed of light in vacuum, and n represents the refractive index of the core of the optical fiber: FUT 7. When the pulse width of the FDM pulses on the time axis is long, Formula (2.1) is used. When the pulse width of the FDM pulses on the time axis is short, Formula (2.2) is used.

In measurement of BGS, the frequency interval of the injected FDM pulses should be sufficiently wide in consideration of two factors: the frequency spread due to the pump light being a pulse and the frequency spread at the time of acquiring Brillouin scattering. That is, although the interval between optical frequency components only needs to be separated by the frequency spread of the FDM pulses or more only in measurement of the Rayleigh scattered light using the FDM pulses is performed, in the present disclosure in which both the FDM phases OTDR and BOTDA are performed, the frequency spread is calculated from convolution of the pulse spectrum of the FDM pulses and a gain spectrum with assumption that the pump light is a continuous wave at a single frequency (from Formula (2) with assumption that the pump light is a rectangular wave).

Referring to Non Patent Literature 2, when the total pulse width of the FDM pulses having three frequencies is 150 ns, a spread of the frequencies is about 38 MHz in the full width at half maximum of the BGS. In this regard, the optical frequency intervals for separation of the FDM pulses need to be 38 MHz or more. In addition, when the frequency band is secured up to about 90% of the maximum value of the BGS instead of the full width at half maximum, it is necessary to set the intervals for separation of the respective frequencies of the FDM pulses to about 100 MHz. In this regard, the three frequencies of the FDM pulses are designed such that differences from the optical frequency of the CW light source 1 are 200 MHz, 300 MHz, and 400 MHz. This makes it practical to simultaneously measure both the FDM phase OTDR and the BOTDA.

In addition, the probe light is subjected to frequency sweep in a range obtained by adding a frequency offset of FDM pulses, as will be described later, to a normally used Brillouin frequency shift range by BOTDA in the optical fiber. Referring to Non Patent Literature 1 with respect to the Brillouin frequency shift range, for example, in a normal silica single mode fiber, frequency sweep of the frequency of a modulation signal is performed in a range of 10650 MHz to 10850 MHz. When the frequency sweep is performed in the aforementioned frequency design of the FDM pulses in this frequency range, only stimulated Brillouin scattering of one specific frequency component of the FDM pulses and the probe light of BOTDA can occur.

In this regard, it is practical to prevent other frequency components of the FDM pulses and the probe light from causing a stimulated Brillouin scattering phenomenon. As a result, the intensity of the probe light is modulated by a signal of only Brillouin scattered light generated by stimulated Brillouin scattering of the one specific frequency component and the probe light of BOTDA. Note that the change ν_{B} in the peak frequency of the BGS changes in accordance with the following formula depending on a change Δ_{ε} in strain applied to the optical fiber of the FUT 7 and a change ΔT in temperature.

$$\begin{matrix}[ Math . 3 ] & \\ {v}_{B} ( Δε , Δ T ) = {C}_{ε} Δε + {C}_{T} Δ T & ( 3 )\end{matrix}$$

Here, C_{ε} is a strain coefficient, C_{T} is a temperature coefficient, which depend on characteristics of the optical fiber of the FUT 7. As an indication of a frequency change, the strain is about 0.05 MHz/με, and the temperature is about 1 MHz/° C. (Non Patent Literature 3). Therefore, in order to measure larger changes in temperature and strain, it is necessary to widen the range of frequency sweep of the probe light. For example, a demand for measurement in the range of 0 to 50° C., even if it causes no change in strain, causes a possibility that the peak frequency of the BGS changes by about 1 MHz*50=50 MHz in accordance with Formula (3). In view of this, it is necessary to expand a sweep range of the probe light such that the peak of the BGS falls within the sweep range.

In Rayleigh scattering, processing similar to that in Patent Literature 1 is performed. Each frequency component of the Rayleigh scattered light generated by the FDM pulses is extracted using a frequency filter, and the phase of the Rayleigh scattered light at each frequency is averaged to obtain the phase in the entire FDM pulses. By observing a change in this phase, it is practical to quantitatively show a rapid change in strain.

Here, in the FDM pulses of the present disclosure, injection time slightly differs for each frequency. Therefore, also in the present disclosure, the time shift may be corrected and the phase may be calculated, as shown in Patent Literature 1. In addition, when the individual frequencies of the FDM pulses are separated, the frequency band included in the Rayleigh scattered light may increase. In this regard, the reception band of the reception unit of the Rayleigh scattered light can be made smaller than the total occupied frequency width of FDM light pulses by using the effect of aliasing.

For example, when the number of frequencies, which the FDM pulses have, is three and differences between the optical frequency of the CW light source 1 and the center frequencies of the respective frequency components are f₁, f₂, and f₃ (sometimes referred to as frequency offsets), differences between the center frequencies of the respective pulses, such as f₂-f₁ and f₃-f₂, need to be separated by an interval (X) determined from the design or more. The frequency occupancy width of the Rayleigh scattered light of each frequency component is defined as Y, and the frequency band of the reception unit of the Rayleigh scattered light is defined as a reception band Z. When X=200 MHz and Y=10 MHz, it is necessary to separate the frequencies of the FDM pulses by X, and thus the differences between the optical frequency of the CW light source 1 and each frequency of the FDM pulses are f₁=100 MHz, f₂=300 MHz, and f₃=500 MHz. Since Z under this condition needs to include all of f₁ to f₃, in consideration of the spread of +100 MHz, 100 MHz is added to the maximum value of f₁, f₂, and f₃, and Z=600 MHz is obtained.

However, even when similar X and Y are employed, Z=400 MHz, with f₁=100 MHz, f₂=300 MHz, and f₃=900 MHz, enables reception of Rayleigh scattered light in a narrower reception band Z using aliasing. Since f₁ and f₂ visible to the reception unit are equal to or less than the reception band Z, f₁=100 MHz and f₂=300 MHz. Since f₃ exceeds the reception band Z=400 MHz, aliasing causes folding, and f₃′ visible to the reception unit is f₃′=Z−|f₃−Z|=−100 MHz.

In this regard, even though folding occurs due to aliasing, the individual components do not overlap each other, and thus the individual frequency components can be correctly separated and the phase calculation can be performed through the method described in Patent Literature 1. In addition, even when the frequency becomes negative at the time of folding, it is practical to determine that a clockwise rotation is a negative frequency and a counterclockwise rotation is a positive frequency, by confirming IQ components and viewing a rotation direction of a phase, so that, even when occupied bands of different optical frequency components overlap as a result of taking an absolute value, it is practical to separate them as long as the positive and negative are different. As a result, the reception band Z of the reception unit of the Rayleigh scattered light, which should be originally set to 600 MHz by reason of 200 MHz×3 (the number of frequencies of the FDM pulses), can be observed at 400 MHz using aliasing.

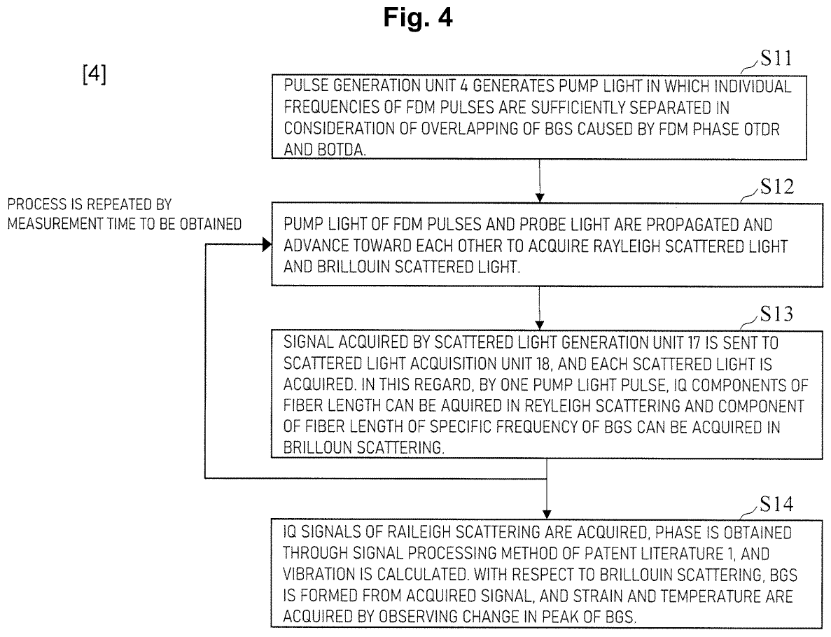

FIG. 4 is a flowchart of a series of procedures according to the present embodiment.
Step S11: The pulse generation unit 4 generates pump light in which individual frequencies of FDM pulses are sufficiently separated in consideration of overlapping of BGSs caused by FDM phase OTDR and BOTDA.
Step S12: The pump light of the FDM pulses and probe light are propagated and advance toward each other to acquire Rayleigh scattered light and Brillouin scattered light.
Step S13: The scattered lights acquired by the scattered light generation unit 17 are sent to the scattered light acquisition unit 18, and the scattered light acquisition unit 18 acquires each scattered light. In this regard, IQ components of the fiber length of the FUT 7 can be acquired from Rayleigh scattering generated by one FDM pulse. On the other hand, information on all BGS can be acquired in the length direction from Brillouin scattering generated by one FDM pulse, and a frequency of one certain point corresponding to the probe light can be acquired in the frequency direction.
Step S14: The arithmetic processing unit 20 acquires signal intensities of an I component and a Q component of Rayleigh scattering, obtains a phase through the signal processing method of Patent Literature 1, and calculates vibration. The arithmetic processing unit 20 forms a BGS from a signal stored in the data acquisition unit 16, and acquires a strain and a temperature by observing a change in a peak of the BGS.

### Effects of Present Disclosure

In accordance with the formulas described in the above embodiment, the frequencies of FDM pulses included in injected pump light are sufficiently separated, and frequency sweep by probe light is performed in the corresponding frequency range, and thus it is practical to avoid interference between BGSs generated from different frequencies of the FDM pulses in BOTDA. As a result, in simultaneous measurement of FDM phase OTDR and BOTDA, it is practical to simultaneously perform highly sensitive measurement of a rapid change in strain due to Rayleigh scattered light and measurement of slow changes in strain and temperature due to Brillouin scattered light.

### INDUSTRIAL APPLICABILITY

The present disclosure can be applied to the information communication industry.

### REFERENCE SIGNS LIST

17 Scattered light generation unit
1 CW light source
2 Modulation signal generator
3 Modulator
4 Pulse generation unit
5 Polarization scrambler
6 Circulator
7 Fiber under test (FUT)
18 Scattered light acquisition unit
8, 11 Circulator
9, 12 Fiber Bragg grating (FBG)
10 Photodetector (PD)
13 90° Hybrid
14, 15 Balanced photodetector (BPD)
16 Data acquisition unit
17 Scattered light generation unit
18 Scattered light acquisition unit
19 Separation unit
20 Arithmetic processing unit

1. An optical measurement system for measuring Rayleigh scattered light and Brillouin scattered light in an optical fiber by injecting light into both ends of the optical fiber,
wherein injected light for the Rayleigh scattering includes frequency multiplexing pulses having a predetermined frequency interval, and
one pulse of the frequency multiplexing pulses is used as pump light for the Brillouin scattering.

2. The optical measurement system according to claim 1, wherein local light is generated by splitting continuous light, and
phase detection of the Rayleigh scattered light generated in the optical fiber is performed using the local light.

3. The optical measurement system according to claim 1, wherein frequency sweep of probe light is performed within a range in which a Brillouin gain spectrum from the pump light is extractable.

4. The optical measurement system according to claim 1, wherein the predetermined frequency interval has a frequency interval wider than a spread of a Brillouin gain spectrum due to a time width of each pulse included in the frequency multiplexing pulses.

5. The optical measurement system according to claim 4, wherein the predetermined frequency interval is determined using convolution of a pulse spectrum of the frequency multiplexing pulses and a gain spectrum with assumption that the pump light is a continuous wave at a single frequency.

6. The optical measurement system according to claim 1, wherein a frequency band of a reception unit of Rayleigh scattered light is narrower than a frequency band of an entire pulse spectrum of the frequency multiplexing pulses.

7. The optical measurement system according to claim 1, wherein the Rayleigh scattered light and the Brillouin scattered light generated in the optical fiber are separated using a fiber Bragg grating (FBG).

8. An optical measurement method of measuring Rayleigh scattered light and Brillouin scattered light in an optical fiber by injecting light into both ends of the optical fiber,
wherein injected light for the Rayleigh scattering includes frequency multiplexing pulses, and
one pulse of the frequency multiplexing pulses is used as pump light for the Brillouin scattering.
